(19) United States
(12) Patent Application Publication
(10) Pub. No.: US 2009/0125736 A1
(43) Pub. Date: May 14, 2009

(54) Home appliance and controlling method of the same

(75) Inventor: Sang Woo Woo, Changwon-si (KR)

Correspondence Address: MCKENNA LONG & ALDRIDGE LLP, 1900 K STREET, NW, WASHINGTON, DC, 20006, US

(73) Assignee: LG ELECTRONICS INC., Yeongdeungpo-gu (KR)

(21) Appl. No.: 12/232,623

(22) Filed: Sep. 19, 2008

(30) Foreign Application Priority Data
Sep. 21, 2007 (KR) 10-2007-0096570

(51) Int. Cl. G06F 1/32; G06F 3/041

(52) U.S. Cl. 713/320; 715/702

(57) ABSTRACT

The present invention is related to a home appliance such as a dish washer, a laundry machine, a refrigerator, etc. One embodiment of a home appliance according to the present invention comprises a control panel and a controller. The controller panel may include a power switch which allows a user to input a command for switching on or off a power of the appliance and an input device which allows the user to input a command in connection with an operation of the appliance.

### CROSS-REFERENCE TO RELATED APPLICATION

This application claims the benefit of Korean Patent Application No. 10-2007-0096570, filed on Sep. 21, 2007 which is hereby incorporated by reference in its entirety as if fully set forth herein.

### BACKGROUND OF THE INVENTION

1. Field of the Invention

The present invention is related to a home appliance such as a dish washer, a laundry machine, a refrigerator, etc.

2. Discussion of the Related Art

Generally speaking, home appliances are electric devices used at home.

Generally, dish washers are used for removing dirty and remaining food from food dishes and eating utensils (hereinafter, collectively referred to as dishes) by injecting wash water onto the dishes at a high pressure.

Such a dish washer includes a tub forming a cleaning chamber and a sump disposed at a lower portion of the tub for storing wash water. A pump is installed in the sump to pump the wash water to an injection nozzle connected to the sump. The wash water arrived at the injection nozzle is injected through a nozzle hole formed in an end of the injection nozzle at a high pressure. Two injection nozzles can be disposed at upper and lower portions of the tub, respectively, and the upper injection nozzle can be connected to the sump by a water guide.

Laundry machines are generally devices for treating laundry. Laundry machines may be clothes dryers or clothes washers.

Generally, clothes dryers are for drying wet laundry and clothes washers are for washing laundry.

### SUMMARY OF THE INVENTION

One embodiment of a home appliance according to the present invention comprises a control panel and a controller.

The controller panel may include a power switch which allows a user to input a command for switching on or off a power of the appliance and an input device which allows the user to input a command in connection with an operation of the appliance.

The controller may be configured to reduce or switch off the power of the appliance when a command is not inputted through the input device within a predetermined period of time after the appliance has been switched on.

The input device may comprise a course selector which allows a user to select a course and an option selector which allows the user to select an option in connection with the course.

Taking a clothes washer as an example, the course may be a normal washing course, lingerie washing course, or the like.

There may be a plurality of courses which the user can select.

The user may select options for the selected course with the option selector. For instance, the user may select a temperature of water for washing clothes with the option selector. In a similar way, there may be plurality of options which the user can select through the option selector.

The power switch may comprise a touch switch which only has to be touched by the user to operate. Further, the touch switch may comprise a capacitance touch switch or a resistance touch switch.

A capacitance touch switch works using body capacitance, a property of the human body that gives it great electrical characteristics. When a person touches it, it increases the capacitance and triggers the switch.

A resistance touch switch works by lowering the resistance between two pieces of metal. Placing one or two fingers across the plates achieves a turn on or closed state.

Alternatively, the power switch may comprise a sensor which senses a user's touch. When the user touches the power switch, the sensor may sense the touch and send a signal to the controller. Then, the controller may reduce or switch off the power of the appliance.

The sensor may comprise a pressure sensor or a heat sensor. The pressure sensor senses the user's touch by pressure, and the heat sensor senses the user's touch by a transmitted heat from the user.

Another embodiment of a home appliance according to the present invention may comprise a controller to reduce or switch off a power of the appliance when a command for switching off the power is inputted twice or more.

The control panel of the previously presented embodiment may be comprised in this embodiment.

The controller may reduce or switch off the power when the command is inputted twice or more through the power switch.

Further, the controller may do so when the number of commands is inputted within a predetermined period of time.

An embodiment of a controlling method of a home appliance may comprises switching on a power of the appliance; and reducing or switching off the power of the appliance when a command in connection with an operation of the appliance is not inputted within a predetermined period of time after the appliance has been switched on.

Another embodiment of a controlling method of a home appliance may comprises switching on a power of the appliance; and switching off the power of the appliance when a command for switching off the power is inputted twice or more within a predetermined period of time.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the invention. In the drawings:

FIG. 1 is a perspective view illustrating the external appearance of a dish washer according to the present invention;

FIG. 2 is a schematic longitudinal sectional view of the dish washer according to the present invention;

FIG. 3 is a constructional view illustrating an input unit of the dish washer according to the present invention; and

FIGS. 4 and 5 are flow charts illustrating a method of controlling the input unit of the dish washer according to the present invention.

### DETAILED DESCRIPTION OF THE INVENTION

Reference will now be made in detail to the preferred embodiments of the present invention, examples of which are illustrated in the accompanying drawings. In an embodiment, a dish washer is described; however, the concept of the present invention is applicable to a laundry machine, for example a washer, a dryer, a washer and dryer, or a steam dryer.

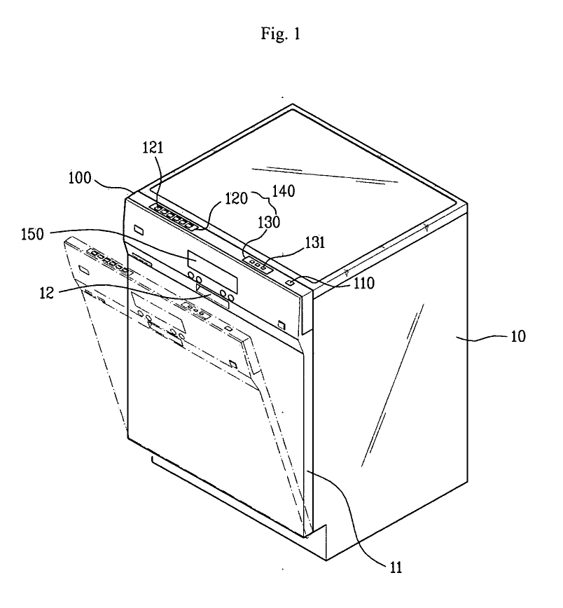

FIG. 1 is a perspective view illustrating a dish washer according to the present invention.

Referring to FIG. 1, the dish washer includes a case 10 forming the external appearance of the dish washer, the case 10 being opened at the front thereof, a door 11 for opening and closing the open front of the case 10, a door grip 12 used for a user to open and close the door 11, and a control panel 100 provided at the upper side of the door 11 for displaying and controlling the operation of the dish washer.

As shown in FIG. 1, the door 11 is hingedly mounted at the lower part of the case 10, and the control panel 100 is provided at the top side of the door 11. When the dish washer is used in a built-in product, cooking equipment, including a microwave oven for cooking, may be mounted at the top of the case 10. With the door 11 mounted by hinges at the lower part of the case 10 or with the control panel 100 provided at the top side of the door 11, it is improved in a way of the user's convenience. That is, the user may open the door 11 and easily put dishes into the case 10. Also, the user may easily input an operation command to operate the dish washer through the control panel 100 provided at the top of the door 11 while keeping the door 11 open.

Meanwhile, the control panel 100 includes a signal generator(or a power switch) 110 for generating a predetermined signal to apply electric power to the dish washer or release the electric power applied to the dish washer, an input device 140 for allowing a user to select a desired washing course, and a display device 150 for displaying the operation state of the dish washer.

The signal generator 110 allows the user to selectively apply electric power to the dish washer or release the electric power applied to the dish washer. The signal generator 110 may be configured in the form of a predetermined button which the user can push. Alternatively, the signal generator 110 may be configured in the form of a predetermined touch sensor or a predetermined touch pad which can sense a touch of the user. When the signal generator 110 is configured in the form of a predetermined button, the signal generator 110 generates a predetermined signal when the user pushes the button. On the other hand, when the signal generator 110 is configured in the form of a predetermined touch sensor or a predetermined touch pad, the signal generator 110 generates a predetermined signal when the user touches the touch sensor or the touch pad.

Also, the dish washer may further include a controller (not shown) for applying electric power to the dish washer or releasing the electric power when a predetermined signal is generated from the signal generator 110. The controller will be described hereinafter in detail.

The input device 140 allows a user to input the detailed commands for a dish washing operation. The input device 140 may include a course selector 120 for allowing the user to select any one of a plurality of predetermined washing courses and an option selector 130 for allowing the user to select any one of a plurality of predetermined options.

The course selector 120 may have a plurality of buttons 121 for allowing the user to select any one of the plurality of predetermined washing courses. Similarly, the option selector 130 may have a plurality of buttons 131 for allowing the user to select any one of the plurality of predetermined options.

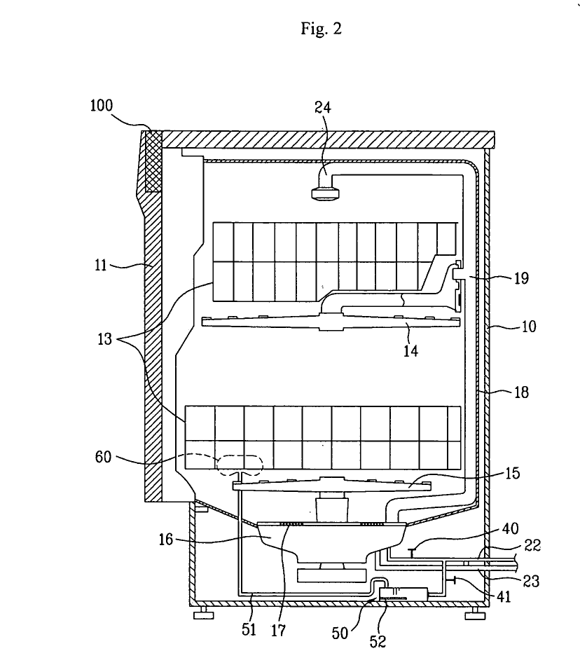

FIG. 2 shows a longitudinal section of the dish washer of FIG. 1.

To describe the internal structure of the dish washer with reference to FIG. 2, the dish washer includes a tub 18 mounted in the case 10 for defining a space where dishes are washed and a sump 16 mounted at the bottom of the tub 18 for collecting wash water to wash the dishes and filtering garbage out of the wash water such that the filtered water can be sprayed to the dishes again.

In the sump 16 is mounted a predetermined pump (not shown), such as an impeller, for pumping out the wash water stored in the sump 16. A heater (not shown) is also mounted in the sump 16 for heating the wash water stored in the sump 16. Consequently, detergent may be easily dissolved in the wash water, and food waste on the dishes may be easily soaked by the heated wash water, thereby improving washing efficiency.

In the tub 18 are mounted racks 13 in which dishes are received, spray arms 14 and 15 for spraying wash water toward the respective racks 13, and a spray arm 24 for spraying wash water from the upper part to the lower part of the tub 18.

At the bottom of the tub 18 may be mounted a filter 17, which filters garbage out of the wash water. In the tub 18, at one side thereof, may be provided a wash water tube 19 for supplying wash water to the spray arms 14 and 24, located at the upper part of the tub 18.

Also, the dish washer may further include a steam generator 50 having a predetermined heater 52 for heating water received in the steam generator 50 to generate steam to be supplied into the tub 18, a steam tube 51 for supplying the steam generated by the steam generator 50 into the tub 18, and at least one nozzle 60 for spraying the steam supplied from the steam tube 51 into the tub 18.

Also, the dish washer may further include a water supply pipe 22 connected to the outside and branched into the tub 18 and the steam generator 50 for supplying water to the tub 18 and the steam generator 50, a drainage pipe 23 for draining the contaminated wash water after the washing of the dishes, and a tub valve 40 and a steam valve 41 for opening and closing the water supply pipe 22 to control the amount of water supplied through the water supply pipe 22. The tub valve 40 controls the amount of water supplied to the tub 18, and the steam valve 41 controls the amount of water supplied to the steam generator 50.

Hereinafter, the operation of the dish washer will be described briefly with reference to FIGS. 1 and 2.

First, when dishwashing is required, a user pushes or touches the signal generator 100 to apply electric power to the dish washer.

Subsequently, the user opens the door 11, puts dishes into the racks 13, and manipulates the input device 140, while keeping the door 11 open, to select a desired washing course of the dishwashing. Of course, it is possible for the user to manipulate the input device 140 after closing the door 11.

Subsequently, when the user closes the door 12 and commences the dishwashing according to the selected washing course, the operation of the dish washer is carried out while the operation state of the dish washer is displayed on the display device 150. The operation of the dish washer is carried out only while the door 12 is closed. Of course, an additional operation button (not shown) may be provided such that the operation of the dish washer can be carried out only when the operation button is pushed.

To describe the operation of the dish washer according to the flow sequence of the wash water flowing in the tub 18, on the other hand, the wash water, sprayed from the spray arms 14, 15, and 24, washes the dishes placed in the racks 13, falls downward, and flows into the sump 16. In the sump 16 is mounted a predetermined pump, such as an impeller. The pump pumps out the wash water such that the wash water is resupplied to the respective spray arms 14, 15, and 24.

In this way, food waste is filtered out by the filter 17, during the circulation of the wash water from the sump 16 to the spray arms 14, 15, and 24, thereby preventing excessive contamination of the wash water or the clogging of the nozzle.

Also, the dish washer may carry out a washing process using steam. To carry out the washing process using steam, steam generated by the steam generator 50 is supplied into the tub 18 through the steam tube 51 and the nozzle 60.

In the dish washer, therefore, it is possible to expect the improvement of washing efficiency of the dish washer which can be further obtained by high-temperature and high-humidity properties of the steam. For example, when the dishes are washed using the steam and the wash water, food waste fixed to the dishes is soaked by the steam, and the food waste is easily removed from the dishes by the high-pressure wash water.

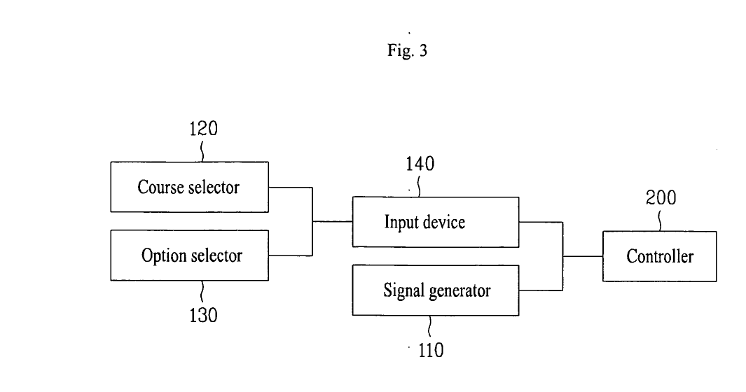

FIG. 3 is a constructional view illustrating an input unit of the dish washer.

Referring to FIG. 3, the input unit of the dish washer includes a signal generator 110, an input device 140, and a controller 200.

The signal generator 110 generates a predetermined signal to apply electric power to the dish washer or release the electric power applied to the dish washer according to the manipulation of a user. Specifically, the user may push or touch the signal generator 110 to apply electric power to the dish washer or release the electric power applied to the dish washer. The signal generator 110 generates a predetermined signal according to the manipulation of the user. The predetermined signal is an electric signal.

The signal generator 110 may be configured to generate a predetermined signal by the user's touching the signal generator 110. For example, the signal generator 110 may be configured in the form of a predetermined touch sensor or a predetermined touch pad which can sense a touch of the user. The touch sensor or the touch pad may sense the touch of the user through the sensing of a predetermined pressure or heat. That is, the signal generator 110 senses a touch of the user through the sensing of a predetermined pressure or heat, thereby generating a predetermined signal

When a predetermined signal is generated from the signal generator 110 according to the manipulation of the user, the controller 200 applies electric power to the dish washer or releases the electric power applied to the dish washer. For example, when a predetermined signal is generated from the signal generator 110, while the electric power is being applied to the dish washer, the controller 200 releases the electric power applied to the dish washer. On the other hand, when a predetermined signal is generated from the signal generator 110, while the electric power applied to the dish washer is being released, the controller 200 applies electric power to the dish washer. Of course, the signal generator 110 generates a signal to apply electric power to the dish washer and a signal to release the electric power applied to the dish washer while distinguishing between the signal to apply the electric power to the dish washer and the signal to release the electric power applied to the dish washer, and the controller applies electric power to the dish washer or releases the electric power applied to the dish washer when one of the two signals is generated while the signal to apply the electric power to the dish washer and the signal to release the electric power applied to the dish washer are distinguished from each other.

The input device 140 may be configured to have a plurality of buttons for allowing a user to select a desired washing course. Alternatively, the input device 140 may be configured in the form of a rotary knob that can be rotated by a predetermined angle for allowing the user to select the washing course. That is, it is possible for the user to select a desired washing course by pressing the button corresponding to the desired washing course or rotating the rotary knob.

As shown in FIG. 3, the input device 140 includes a course selector 120 and an option selector 130. The course selector 120 is an input device component that allows a user to select any one of a plurality of predetermined washing courses, and the option selector 130 is an input device component that allows the user to select any one of a plurality of predetermined options. The predetermined washing courses may include normal washing, strong washing, and rinsing. The predetermined options may include steam and drying. When one of the washing courses and one of the options are selected, dishwashing is carried out according to a course including the selected washing course and the selected option. Also, the input device 140 may further include a detail establisher for allowing a user to establish temperature, time, and the number of repetitions in the washing courses and the options in detail.

Meanwhile, the controller 200 releases the electric power applied to the dish washer when one of the washing courses is not selected within a predetermined time after the electric power is applied to the dish washer as a result of the generation of a predetermined signal from the signal generator 110. This is because the electric power may be wasted when the application of the electric power to the dish washer is maintained in a case in which the electric power is applied to the dish washer without the intention of the user as in a case in which electric power is applied to the dish washer as a result of the generation of a predetermined signal from the signal generator 110 caused by the operation of the signal generator 110 due to a mistake or unintended action of the user or other unintended cause.

That is, a user touches the signal generator 110 to apply electric power to the dish washer, and select one of the washing courses through the input device 140 to perform the dishwashing. At this time, the controller 200 determines that the electric power has been applied to the dish washer without the intention of the user, when one of the washing courses is not selected within a predetermined time after the electric power is applied to the dish washer, and releases the electric power applied to the dish washer, thereby preventing the waste of the electric power.

Also, the controller 200 releases the electric power applied to the dish washer only when a predetermined signal is generated from the signal generator 110 during the dishwashing and then another predetermined signal is generated from the signal generator 110 within a predetermined time. This is because, the operation of the dish washer may stop without the intention of the user if the electric power applied to the dish washer is released when a predetermined signal is generated from the signal generator 110 during the dishwashing. If the electric power applied to the dish washer is released without the intention of the user during the dishwashing, whereby the operation of the dish washer stops, the user must apply electric power to the dish washer again to perform the dishwashing again from the beginning, which is troublesome and inconvenient.

Consequently, it is possible to prevent the electric power applied to the dish washer from being released without the intention of the user not by the controller 200 releasing the electric power applied to the dish washer immediately when a predetermined signal is generated from the signal generator 110 during the dishwashing but by the controller 200 releasing the electric power applied to the dish washer only when another predetermined signal is generated from the signal generator 110 within a predetermined time.

In this case, in order to release the electric power applied to the dish washer during the dishwashing, the user touches the signal generator 110, such that a predetermined signal is generated from the signal generator 110, and touches the signal generator 110 again within a predetermined time, such that the electric power applied to the dish washer is released.

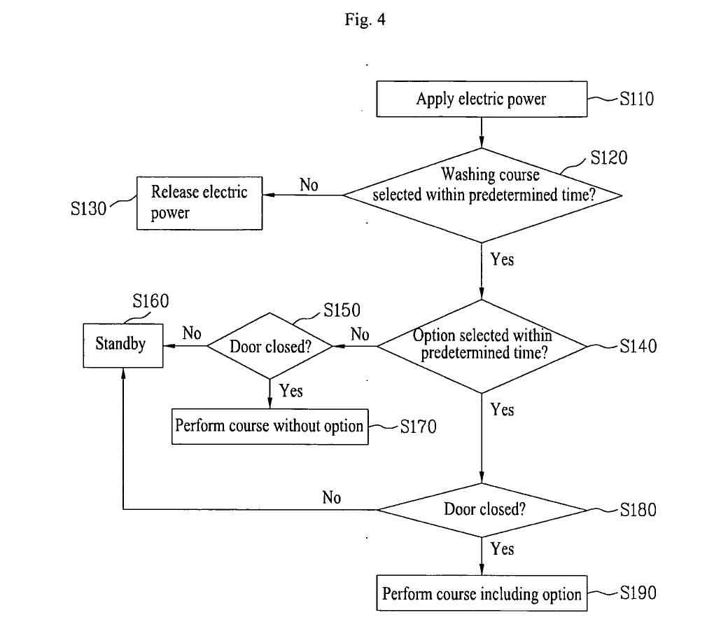

FIG. 4 is a flow chart illustrating a method of controlling the input unit of the dish washer. Specifically, FIG. 4 illustrates a series of processes from the application of electric power to the performance of dishwashing.

The processes from the application of electric power to the performance of dishwashing will be described with reference to FIG. 4.

First, when a predetermined signal is generated from the signal generator 110, electric power is applied to the dish washer (S110). When the electric power is applied to the dish washer, it is determined whether any one of the predetermined washing courses has been selected within a predetermined time (S120).

When it is determined that one of the predetermined washing courses has not been selected within the predetermined time, it is determined that the electric power has been applied to the dish washer without the intention of a user, and the electric power is applied to the dish washer is released (S130). On the other hand, when it is determined that one of the predetermined washing courses has been selected within the predetermined time, it is determined whether any one of the predetermined options has been selected within a predetermined time (S140).

When it is determined the one of the predetermined options has not been selected within the predetermined time, it is determined whether the door 11 is closed (S150). When it is determined that the door 11 is open, the dish washer is on standby (S160). On the other hand, when it is determined that the door 11 is closed, the dishwashing is carried out according to the selected washing course without any option (S170).

On the other hand, when one of the predetermined options has been selected within the predetermined time, it is determined whether the door 11 is closed (S180). When it is determined that the door 11 is open, the dish washer is on standby (S160). On the other hand, when it is determined that the door 11 is closed, the dishwashing is carried out according to a course including the selected washing course and the selected option (S190).

In the method of controlling the input unit of the dish washer, therefore, it is possible to release the electric power applied to the dish washer when the application of the electric power to the dish washer is not intended by the user although the signal is generated from the signal generator 110 with the result that the electric power is applied to the dish washer, and therefore, it is possible to prevent the continuous application of the electric power to the dish washer, thereby preventing the waste of the electric power. That is, in the method of controlling the input unit of the dish washer, it is possible to release the electric power applied to the dish washer when a washing course or a washing course including an option is not selected although a predetermined signal is generated from the signal generator 110 with the result that the electric power is applied to the dish washer.

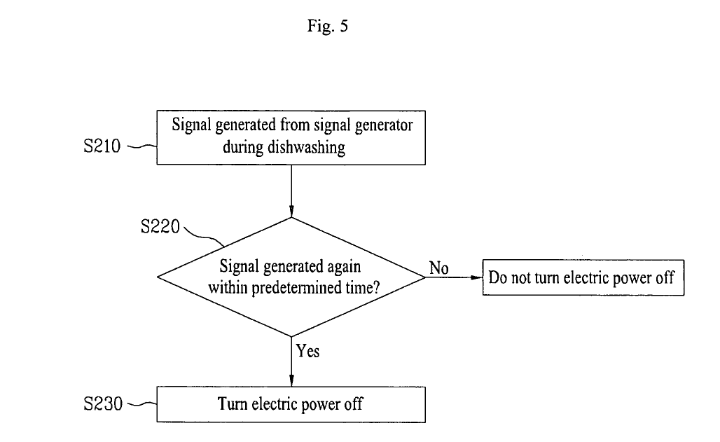

FIG. 5 is a flow chart illustrating a method of controlling the input unit of the dish washer. Specifically, FIG. 5 illustrates a process for releasing the electric power applied to the dish washer during the dishwashing.

The process for releasing the electric power applied to the dish washer during the dishwashing will be described with reference to FIG. 5.

First, when a predetermined signal has been generated from the signal generator 110 during the dishwashing (S210), it is determined whether another predetermined signal has been generated from the signal generator 110 within a predetermined time (S220).

When it is determined that the another predetermined signal has been generated from the signal generator 110 within the predetermined time, the electric power applied to the dish washer is released with the result that the dishwashing stops (S230).

On the other hand, when it is determined that the another predetermined signal has not been generated from the signal generator 110 within the predetermined time, the electric power applied to the dish washer is not released with the result that the dishwashing continues (S240). That is, it is determined that the first signal has been generated from the signal generator 110 by a mistake of the user or the malfunction of the dish washer due to an external cause, and therefore, the electric power applied to the dish washer is not released.

In the method of controlling the input unit of the dish washer, therefore, it is possible to release the electric power applied to the dish washer only when a predetermined signal is generated from the signal generator 110 according to the intention of the user during the dishwashing, and therefore, it is possible to prevent the electric power applied to the dish washer from being released when the signal is generated from the signal generator 110 by a mistake of the user or the malfunction of the dish washer due to an external cause. That is, it is possible to release the electric power applied to the dish washer only when the user pushes or touches the signal generator 111 twice at predetermined time intervals, and therefore, it is possible to prevent the electric power applied to the dish washer from being released by a mistake of the user or the malfunction of the dish washer due to an external cause during the dishwashing.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A home appliance comprising:
a control panel including a power switch which allows a user to input a command for switching on or off a power of the appliance and an input device which allows the user to input a command in connection with an operation of the appliance; and
a controller to reduce or switch off the power of the appliance when a command is not inputted through the input device within a predetermined period of time after the appliance has been switched on.

2. The home appliance of claim 1, wherein the power switch comprises a touch switch which only has to be touched by the user to operate.

3. The home appliance of claim 2, wherein the touch switch comprises a capacitance touch switch or a resistance touch switch.

4. The home appliance of claim 1, wherein the power switch comprises a sensor which senses a user's touch.

5. The home appliance of claim 4, wherein the sensor comprises a pressure sensor or a heat sensor.

6. The home appliance of claim 1, wherein the input device comprises a course selector which allows a user to select a course and an option selector which allows the user to select an option in connection with the course.

7. A home appliance comprising:
a control panel including a power switch which allows a user to input a command for switching on or off a power of the appliance; and
a controller to reduce or switch off the power of the appliance when the command is inputted twice or more through the power switch within a predetermined period of time.

8. The home appliance of claim 7, wherein the power switch comprises a touch switch which only has to be touched by the user to operate.

9. The home appliance of claim 8, wherein the touch switch comprises a capacitance touch switch or a resistance touch switch.

10. The home appliance of claim 7, wherein the power switch comprises a sensor which senses a user's touch.

11. The home appliance of claim 10, wherein the sensor comprises a pressure sensor or a heat sensor.

12. The home appliance of claim 1, wherein the appliance is a dish washer or a laundry machine.

13. The home appliance of claim 7, wherein the appliance is a dish washer or a laundry machine.

14. A controlling method of a home appliance, the method comprising:
switching on a power of the appliance; and
reducing or switching off the power of the appliance when a command in connection with an operation of the appliance is not inputted within a predetermined period of time after the appliance has been switched on.

15. A controlling method of a home appliance, the method comprising:
switching on a power of the appliance; and
switching off the power of the appliance when a command for switching off the power is inputted twice or more within a predetermined period of time.
